(19) United States
(12) Patent Application Publication
(10) Pub. No.: US 2021/0331222 A1
(43) Pub. Date: Oct. 28, 2021

(54) CASTING-ROLLING INSTALLATION AND METHOD FOR TREATING A WORKPIECE BY MEANS OF SUCH AN INSTALLATION

(71) Applicant: Primetals Technologies Austria GmbH, Linz (AT)

(72) Inventors: Sergey BRAGIN, Linz (AT); Thomas PFATSCHBACHER, Kirchschlag (AT)

(21) Appl. No.: 16/479,724

(22) PCT Filed: Jan. 22, 2018
(86) PCT No.: PCT/EP2018/051404

§ 371 Date: Jul. 22, 2019

(30) Foreign Application Priority Data
Jan. 24, 2017 (EP) 17152828.4

(51) Int. Cl. B21B 1/46; B21B 45/00; B21B 45/02; B21B 37/74

(52) U.S. Cl. CPC B21B 1/463; B21B 45/004; B21B 2201/10; B21B 37/74; B21B 45/0218

(57) ABSTRACT

A casting-rolling installation (10) with at least one finishing train (12), having at least a last roll stand (14) and with a cooling device (16) arranged downstream of the finishing train (12). To achieve a metallurgically advantageous microstructure, at least one temperature adjusting element (18) is provided, for increasing or at least substantially keeping constant a temperature of an object, in particular a workpiece, in order to counteract cooling of the object or the workpiece, which temperature adjusting element is arranged after the last roll stand (14) and before the cooling device (16) and/or is arranged after the last roll stand (14) and after the cooling device (16).

### CROSS-REFERENCE TO RELATED APPLICATIONS

The present application is a 35 U.S.C. §§ 371 national phase conversion of PCT/EP2018/051404, filed Jan. 22, 2018, the contents of which are incorporated herein by reference which claims priority of European Application No. 17152828.4, filed Jan. 24, 2017, the contents of which are incorporated by reference herein. The PCT International Application was published in the German language.

### FIELD OF THE INVENTION

The invention relates to a casting-rolling installation and to a method for treating a workpiece by means of such a casting-rolling installation.

### TECHNICAL BACKGROUND

Modern casting-rolling installations comprise a casting installation for continuously casting a workpiece, for example a strip or a long product, followed, for example, by three roll stands for reducing a strip thickness of the continuously cast workpiece, for example an inductive heater, although it does not have to be an inductive heater, for heating the workpiece, for example a five-stand, finishing or final rolling train for further reducing the strip thickness of the workpiece, a cooling zone for cooling the workpiece and, after the latter, a winding device for winding up the workpiece, for example a coiler, in which the workpiece is wound into coils.

Such casting-rolling installations, in which the casting process and the rolling process are coupled, can operate in endless mode, i.e. the workpiece runs through the installation in a workpiece conveying direction or strip run-through direction, from the casting installation to before the coiler without being cut through in the ESP installation as it runs through (so-called ESP installations, the acronym ESP standing for “Endless Strip Production”), or in a batch mode, here the casting process being coupled with the rolling process by way of a buffer store.

Since in such an ESP installation in endless mode, the workpiece is not cut, a rolling speed during the finishing rolling or final rolling has a fixed relationship with a mass flow during the continuous casting.

Because a final rolling temperature during the finishing or final rolling depends on the rolling speed there, the final rolling temperature is consequently likewise limited by the mass flow during the continuous casting.

If different physical properties are achieved in the processed workpiece as a result of the final rolling temperature during the finishing or final rolling, in particular by way of the metallurgical microstructures in the workpiece that can be adjusted in this way, consequently a restriction is thus also obtained on the types of steel that can be produced by this endless rolling process.

WO 2004/108971 A2 discloses a casting-rolling installation in which a number of intensive cooling boxes are arranged within a cooling zone arranged after a finishing train.

### SUMMARY OF THE INVENTION

One object of the invention is to overcome the disadvantages set out above and in particular to provide a casting-rolling installation that can be used in a versatile way. During such use, a workpiece with a metallurgically advantageous microstructure can be achieved, and by means of that, a wide variety of types of steel can be produced.

Another object of the invention is to provide a method which makes it possible to produce a workpiece with a metallurgically advantageous microstructure and also allows the operation of the casting-rolling installation, in particular also in endless mode.

These objects are achieved according to the invention by a casting-rolling installation and by a method with the features disclosed herein. Favorable configurations and advantages of the invention can also be obtained from the further claims and the description.

The invention is based on a casting-rolling installation, for example, a so-called ESP installation, with at least one finishing train which has at least a last roll stand, and with a cooling device which is arranged downstream of the finishing train.

In this case, terms such as “after” or “arranged after”, “before” or “arranged before”, “behind” or “behind one another” and the like can be understood with reference to a workpiece conveying direction of a workpiece through the casting-rolling installation, i.e. a direction of movement of the workpiece through the casting-rolling installation. For short, in simplified and illustrative terms, components or installation parts of the casting-rolling installation are arranged one behind the other or one after the other in the casting-rolling installation with reference to the workpiece conveying direction of the casting-rolling installation or the direction of workpiece movement through the casting-rolling installation. “Arranged downstream” means that, with respect to the workpiece conveying direction of the casting-rolling installation or with respect to the direction of movement of the workpiece through the casting-rolling installation, the cooling device is arranged after the finishing train or the last roll stand thereof. By analogy, “arranged upstream” with respect to the workpiece conveying direction of the casting-rolling installation or with respect to the direction of movement of the workpiece through the casting-rolling installation, the finishing train or the last roll stand thereof is arranged before the cooling device. These two alternatives may be mutually exclusive.

It is proposed that the casting-rolling installation have at least one temperature adjusting element, for increasing or at least substantially keeping constant a temperature of an object, in particular of a workpiece, in order to counteract cooling of the object or of the workpiece. The temperature adjusting element is arranged after the last roll stand and before the cooling device and/or is arranged after the last roll stand and furthermore also after the cooling device. Advantageously, the at least one temperature adjusting element is arranged between the last roll stand and the cooling device.

A temperature adjusting element may be understood in this case as meaning an element or device that is suitable for increasing or at least substantially keeping constant a temperature of an object, in particular of the workpiece, i.e. counteracting cooling at its effective location, for example a furnace, in particular a chamber furnace, a gas burner, an inductive heat source (furnace, booster) or an insulation, in particular an insulating covering or insulating panel.

In other words, this temperature adjusting element is in particular an “active” element or “active” device, which actively feeds thermal energy to the object or the workpiece, for example in an activatable manner.

In principle, one or more temperature adjusting elements may also be provided in each position before and after the cooling device.

By the arrangement according to the invention, a softening process, a grain growth and a coarsening of precipitates can be, specifically, induced in the microstructure of the workpiece. In this way, a workpiece, for example a metal strip, with an intended, i.e. metallurgically advantageous, microstructure can then be advantageously achieved. This makes possible the production of a great range of different types of steel, for example electric sheets.

Furthermore, in this way microstructures and physical properties can also be achieved or adjusted in the workpiece for possibly further processing stages.

Similarly, the operation of the casting-rolling installation according to the invention is allowed in all operating modes, in particular in endless mode, and in batch mode.

Thus, by the casting-rolling installation according to the invention, in particular electric sheets can be produced in endless mode. This is possible since, as a result of the use of the temperature adjusting element in the workpiece, after the last roll stand, a temperature increase can again be carried out or a further temperature increase can be carried out, whereby a coarse graining of the material and coarse precipitates can be advantageously achieved.

According to a development, the temperature adjusting element is a heating device, whereby conditions that lead to metallurgically advantageous microstructures, for example increased/high temperatures in the workpiece, are provided particularly easily.

According to a preferred configuration of the invention, the heating device has an inductive furnace. In this way, a temperature increase can take place particularly quickly and flexibly, for example “pulse-like introduction of temperature into the workpiece”, “booster”. Such an inductive furnace or booster or a number of such inductive furnaces or boosters, one behind the other, may be provided here. A booster is a device that can increase the temperature of an object.

Alternatively and/or additionally, the temperature adjusting element may have a heat storage device. In this way, an energy-saving configuration can be provided.

A “heat storage device” means a device which keeps a temperature of the workpiece substantially constant and/or counteracts cooling of the same, or can prevent such cooling.

The heat device may be formed by any element or group of elements deemed applicable by a person skilled in the art, for example an enclosure, a covering or a panel. Preferably, the heat storage device has heat insulating properties.

Advantageously, the heat storage device has at least one panel, whereby it is of a structurally simple design and can be used easily. In particular, the heat storage device is a pivotable, insulating panel, whereby the temperature can be kept approximately constant particularly effectively. The pivotable panel may for example be designed as pivotable about/over the workpiece or a portion of the installation guiding the workpiece. The insulating panel covers the hot, rolled strip or sheet and thereby insulates it against the ambient surroundings. The panel thereby preserves or retains the temperature of the strip or sheet.

In an advantageous development, the temperature adjusting element is arranged between 1 meter and 25 meters, preferably between 5 meters and 20 meters, and particularly preferably between 10 meters and 15 meters, before the cooling device. For these distances, it has been possible to show that a metallurgically advantageous microstructure, such as a large grain size, can be adjusted in the workpiece at feasible rolling speeds or workpiece speeds.

Preferably, the temperature adjusting element may also be arranged between 0.5 meters and 10 meters, preferably between 0.5 meters and 5 meters, and particularly preferably between 0.5 meters and 2 meters, after the last roll stand. Here, too, it has been possible to show that for these distances a metallurgically advantageous microstructure, such as a large grain size, can be adjusted in the workpiece at feasible rolling speeds or workpiece speeds.

An effective and rapid cooling can take place if the cooling device of the casting-rolling installation is a laminar or turbo-laminar cooling device or a pressure cooling device. Cooling liquid, such as certain coolants or else water, may be used here, for example for the cooling.

The invention also relates to a method for treating a workpiece in a casting-rolling installation according to the invention, comprising at least the finishing train which has at least the last roll stand, with the cooling device which is arranged downstream of the finishing train and with the at least one temperature adjusting element, which is arranged after the last roll stand and before the cooling device and/or which is arranged after the last roll stand and also after the cooling device.

It is proposed that the workpiece is heat treated using the temperature adjusting element, in particular its temperature is, in particular actively increased or “(approximately”) “held”.

By the method according to the invention, a softening process, a grain growth and a coarsening of precipitates can be, specifically, induced in the microstructure of the workpiece. In this way, a workpiece, for example a long product or a metal strip, with an intended, i.e. metallurgically advantageous, microstructure can then be advantageously achieved. This therefore makes possible the production of a great range of different types of steel, for example electric sheets.

Furthermore, in this way micro structures and physical properties can also be achieved or adjusted in the workpiece for possible further processing stages.

Similarly, the operation of the casting-rolling installation according to the invention is allowed in all modes, in particular in endless mode and in batch mode.

Thus, by the method according to the invention, in particular electric sheets can be produced in endless mode. An electric sheet is defined in German DIN EN 10106 as an electrical steel strip and sheet, and particularly a cast and rolled, non-oriented electrical steel strip or sheet delivered in a fully pressed state. This is possible since, as a result of the treatment by the temperature adjusting element in the workpiece, after the last roll stand, a temperature increase can again be carried out or a further temperature increase can be carried out, whereby a coarse graining of the material and coarse precipitates can be advantageously achieved.

According to a preferred configuration of the invention, the temperature adjusting element is arranged after the last roll stand and before the cooling device and the workpiece is treated using the temperature adjusting element. In this way, an accumulated strain in the workpiece after rolling and an increased temperature in the workpiece can be achieved because of the temperature adjusting element, speeding up formation of the coarse graining and the coarsening of the precipitates.

Alternatively, the temperature adjusting element is arranged after the last roll stand and after the cooling device and the workpiece is treated using the temperature adjusting element. Under some circumstances, in this way it is likewise possible once again to achieve a coarsening of the grain at the winding device or at the coiler, with positive effects on the electromagnetic properties in the further processing steps.

Advantageously, the temperature adjusting element is a heating device by which the workpiece is heated by 10° C. to 150° C., preferably by 20° C. to 120° C., and particularly preferably by 50° C. to 100° C., using the heating device. These temperature increases, at feasible rolling speeds or workpiece speeds and after the last roll stand enable the workpiece to be heated once again, whereby a coarsening of the grain is induced and coarse precipitates, are produced with positive effects on the material properties, specifically electromagnetic properties after subsequent working steps on the workpiece.

If the temperature increase relates to a temperature of the workpiece as it leaves the last roll stand, i.e. the temperature adjusting element or the heating device is arranged after the last roll stand and before the cooling device. This temperature is generally about 790° C. to 920° C., whereby the temperature of the workpiece is increased to about 800° C. to 1100° C. using the temperature adjusting element.

A further embodiment of the invention provides that the temperature adjusting element is a heating device, in particular a “rapidly acting” heating device, for example an inductive furnace, and the workpiece is heated for between 0.1 seconds and 10 seconds, preferably for between 0.1 seconds and 5 seconds, and particularly preferably for between 0.1 seconds and 1 second, using the heating device. These times showed positive effects on the adjusted metallurgical microstructures.

The heating time may in this case also be chosen depending on various factors, for example, a workpiece speed. In the case a heat storage device as the temperature adjusting element, for example also depending on the length of the heat storage device.

The description given above of advantageous configurations of the invention includes numerous features that are disclosed herein. In some cases the features are together. However, these features may expediently also be considered individually and combined into appropriate further combinations. In particular, these features can be respectively combined individually and in any suitable combination with the method according to the invention and the casting-rolling installation according to the invention. Furthermore, method features can also be regarded as properties of the corresponding device unit.

Even though some terms are used in each case in the singular or in combination with a numeral in the description and/or in the patent claims, the scope of the invention is not intended to be limited to the singular or the respective numeral for these terms.

The properties, features and advantages of the invention described above and the manner in which they are achieved will become clearer and more clearly understandable in conjunction with the following description of the exemplary embodiment of the invention, which is explained in greater detail in conjunction with the drawings. The exemplary embodiment is used to explain the invention and does not restrict the invention to the combinations of features, including with respect to functional features, that are specified therein. For this purpose, it is furthermore also possible for suitable features of the exemplary embodiment to be considered explicitly in isolation.

### BRIEF DESCRIPTION OF THE DRAWINGS

The invention is explained in more detail on the basis of exemplary embodiments, which are shown in the drawings and in which:

FIG. 1 shows a casting-rolling installation according to the invention which has a rolling train with two roll stands, a cooling device and a coiler installation,

FIG. 2 shows a diagram which illustrates a temperature of a workpiece that is processed in the casting-rolling installation of FIG. 1 depending on time and the effects of heating and cooling the workpiece,

FIG. 3 shows a diagram which illustrates an austenitic grain size and a recrystallization of a material of the workpiece that is processed in the casting-rolling installation of FIG. 1, depending on time and the effects of inductive heating and cooling of the workpiece,

FIG. 4 shows a casting-rolling installation according to the prior art,

FIG. 5 shows a diagram which illustrates a temperature of a workpiece that is processed in the casting-rolling installation of FIG. 4, depending on time and the effect of cooling of the workpiece,

FIG. 6 shows a diagram which illustrates an austenitic grain size and a recrystallization of a material of the workpiece that is processed in the casting-rolling installation of FIG. 4, depending on time and

FIG. 7 shows a table which shows dependency of an austenite-ferrite conversion on a temperature of an inductive heating and a distance between the inductive heating and the cooling.

### DESCRIPTION OF EMBODIMENTS

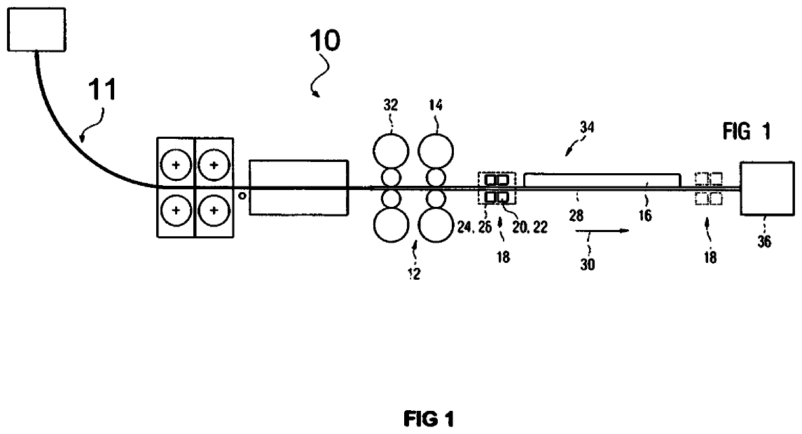

FIG. 1 schematically shows part of a casting-rolling installation 10 in the form of an ESP installation (“Endless Strip Production”).

In the running-through direction/direction of movement 30 of an “endless” workpiece 28, for example a metal strip, the casting-rolling installation 10 comprises a casting installation 11 of a type well known in the art, followed by a finishing train 12 with a plurality of roll stands or a front roll stand 32 and a last roll stand 14. In FIG. 1, those two roll stands are shown for example, a temperature adjusting element 18, a cooling zone 34 with a laminar cooling device 16 and a coiling installation 36.

The temperature adjusting element 18 is consequently arranged between the last roll stand 14 of the rolling train 12 and the cooling device 16. The temperature adjusting element 18 may for example be arranged between 1 meter and 25 meters, preferably between 5 meters and 20 meters, and particularly preferably between 10 meters and 15 meters, before the cooling device 16. Furthermore, the temperature adjusting element 18 may be arranged between 0.5 meters and 10 meters, preferably between 0.5 meters and 5 meters, and particularly preferably between 0.5 meters and 2 meters, after the last roll stand 14.

Furthermore, the temperature adjusting element 18 is formed as a heating device 20, in the form of an inductive furnace 22 shown schematically with for example two boosters, and the workpiece 28 is transported through the furnace 22.

Alternatively, the temperature adjusting element 18 may also be arranged after the cooling device 16 or between the cooling device 16 and the coiler 36. This is a negative limitation, as they are mutually exclusive and the presence of either one means the other is not present.

Moreover, a temperature adjusting element 18 may be provided at both positions, i.e. before and after the cooling device 16. This is a third alternative and also a negative limitation, because it means that having the temperature adjusting element at only one of the locations is not present but only having that element both locations are present.

Alternatively and/or additionally, the temperature adjusting element 18 may be formed as a heat storage device 24 or may have such a device.

This heat storage device 24 is formed for example as an insulating panel 26, which is or can be arranged around the workpiece 28 or can be arranged around it. The panel 26 may for example also be pivotably designed. As described above, the panel covers the workpiece and insulates it against the ambient surroundings, preserving or retaining the temperature of the workpiece.

According to a method for treating the workpiece 28 in the casting-rolling installation 10, the workpiece 28 is treated using the temperature adjusting element 18 to be precise for example in that the temperature adjusting element 18 as shown in solid lines in FIG. 1 is arranged after the last roll stand 14 and before the cooling device 16 and the workpiece 28 is treated at this first selected location using the temperature adjusting element 18.

Alternatively and/or additionally, the temperature adjusting element 18 is arranged after the last roll stand 14 and after the cooling device 16 as shown in broken lines in FIG. 1 and the workpiece 28 is treated at this second alternative location using the temperature adjusting element 18.

In the case of the configuration of the temperature adjusting element 18 at the first location as a heating device 20, the workpiece 28 may be heated by 10° C. to 150° C., preferably by 20° C. to 120° C., and particularly preferably by 50° C. to 100° C., using the heating device 20. This heating takes place for example between 0.1 seconds and 10 seconds, preferably between 0.1 seconds and 5 seconds, and particularly preferably between 0.1 seconds and 1 second.

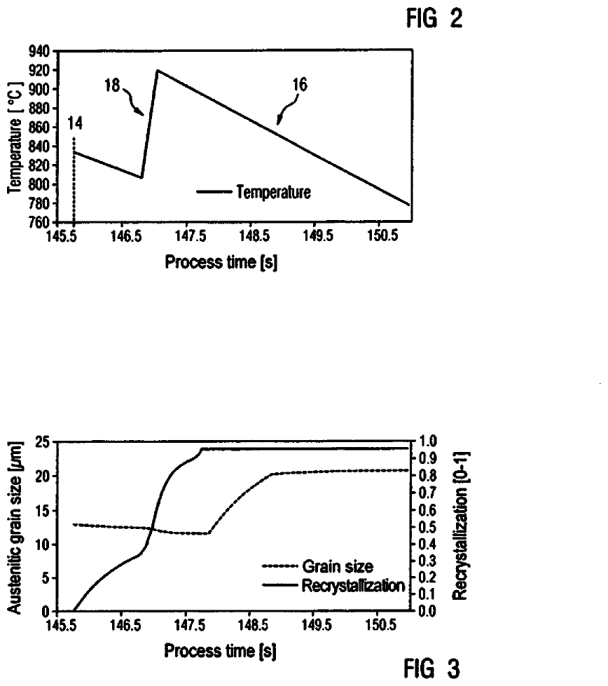

The effect of the temperature adjusting element 18 or of the inductive furnace 22 on a development of the microstructure in a workpiece 28 was simulated for the Applicant. The results are reproduced in the diagrams of FIG. 2 and FIG. 3.

FIG. 2 shows a diagram illustrating a temperature or a temperature profile in ° C. of the workpiece 28 that is processed in the casting-rolling installation of FIG. 1, from when it leaves the last roll stand 14 and depending on the process time in seconds.

The temperature profile illustrated in FIG. 2 shows the temperature effects on the workpiece during heating by the temperature adjusting element 18 that is a “steep temperature increase” following a “slight cooling” as the workpiece leaves the last roll stand 14 and shows cooling of the workpiece by the cooling device 16 in a subsequent “temperature drop”.

FIG. 3 shows a diagram which illustrates an austenitic grain size in μm and a recrystallization in values of 0 to 1 in the material of the workpiece 28 from when it leaves the last roll stand 14, and depending on the process time in seconds as detailed below.

For comparison with FIGS. 1-3, the same simulation was carried out on a casting-rolling installation 100 according to the prior art, which is without using a temperature adjusting element. This casting-rolling installation 100 is shown in FIG. 4.

Elements in FIG. 4 of the same types as shown in the casting-rolling installation 10, which is according to the invention, are denoted by the same designations in FIG. 4.

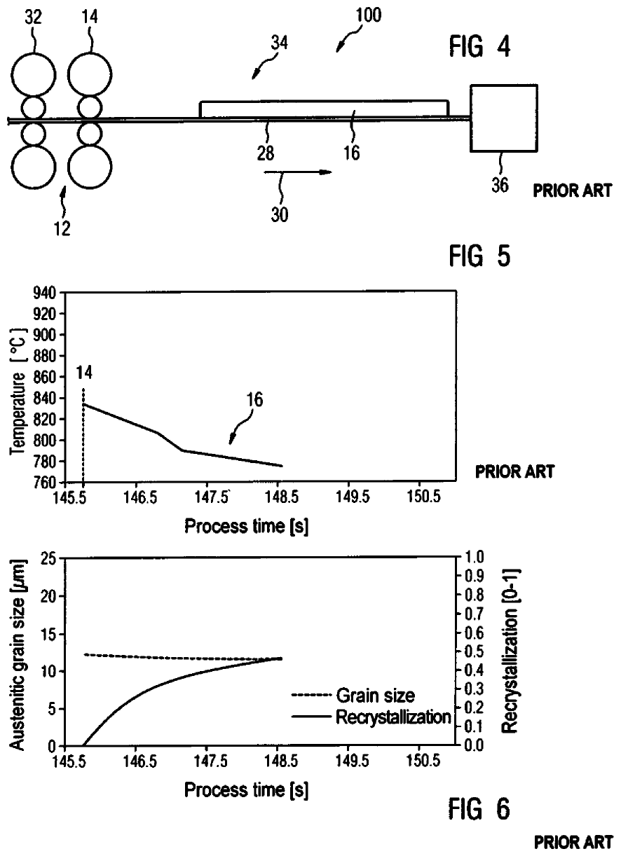

The results of the simulation of FIG. 4 are in turn reproduced in the diagrams of FIG. 5 in kind corresponding to FIG. 2 and FIG. 6 corresponding in kind to FIG. 3 entries along axes analogous to those in FIGS. 2 and 3. The simulation for the installation of the prior art was interrupted before the austenite-ferrite conversion.

As can be seen in FIG. 5, after the workpiece leaves the last roll stand 14, the temperature falls almost constantly if no temperature adjusting element is used. As can be seen in FIG. 6, the microstructure is only partly recrystallized after the last roll stand 14. Grains are refined during the recrystallization. Since the grain growth can only begin after the recrystallization, the austenite grains do not grow.

A different result is obtained if a temperature adjusting element 18 is used according to the invention. The temperature profile illustrated in FIG. 2 shows that after the workpiece leaves the last roll stand 14, a slight temperature drop occurs by about 30° C. from 840° C. to 810° C. The use of the temperature adjusting element 18 or the inductive furnace 22 for about 0.5 seconds causes a rapid temperature increase of about 90° C. from about 810° C. to about 920° C. After that, use of the cooling device 16 also causes a steady temperature drop to about 780° C.

As can be seen in FIG. 3, an increase of the temperature to about 920° C. causes ending of the recrystallization and the austenite grain growth. It can be seen well that the increase of the temperature between the last roll stand 14 and the laminate cooling device 16 brings about the softening of the microstructure and substantially the increase in size of the microstructure.

This conclusion can also be drawn from the values of the table of FIG. 7. The table shows the increase in the austenite grain size before the austenite-ferrite conversion in percent (%), 100% representing the austenitic grain size without inductive heating.

Results for three different temperatures (880° C., 900° C. and 920° C.) and for three different distances between the temperature adjusting element 18 and the beginning of the cooling by the cooling device 16 are shown (0 meters, 10 meters and 20 meters).

If the cooling begins directly after the heating (0 meters) at a temperature of 880° C., the austenite-ferrite conversion corresponds to 100%; it is therefore equal to being without inductive heating. The percentage value increases however up to 202% if either the temperature and/or the distance is/are increased.

Although the invention has been illustrated more specifically and described in detail by the preferred exemplary embodiment, the invention is not restricted by the example disclosed and other variations may be derived therefrom without departing from the scope of protection of the invention.

### LIST OF DESIGNATIONS

10 Casting-rolling installation
12 Finishing train
14 Roll stand
16 Cooling device
18 Temperature adjusting element
20 Heating device
22 Furnace
24 Heat storage device
26 Panel
28 Workpiece (metal strip)
30 Direction of movement
32 Roll stand
34 Cooling zone
36 Coiling installation
100 Casting-rolling installation

1. A casting-rolling installation for a workpiece in a form of a metal strip or a long product, the casting-rolling installation comprising a casting installation for casting the workpiece and a finishing train following the casting installation;
the casting installation and the finishing train being configured and operable to convey the workpiece through the casting installation and the finishing train downstream in a conveying or through direction;
the finishing train comprising at least a last roll stand;
a cooling device arranged downstream of the last roll stand in the workpiece conveying direction and located and operable for cooling the workpiece as the workpiece is conveyed past the cooling device;
the cooling device comprising at least one temperature adjusting element located and operable for increasing or at least keeping substantially constant a temperature of a workpiece being conveyed, in order to counteract cooling of the workpiece, the temperature adjusting element being arranged at least at one of after the last roll stand and before the cooling device and/or after the last roll stand and after the cooling device in the conveying or through direction.

2. The casting-rolling installation as claimed in claim 1, wherein the temperature adjusting element comprises a heating device.

3. The casting-rolling installation as claimed in claim 2, wherein the heating device comprises an inductive furnace.

4. The casting-rolling installation as claimed in claim 2, wherein the temperature adjusting element comprises a heat storage device.

5. The casting-rolling installation as claimed in claim 4, wherein the heat storage device has at least one panel.

6. The casting-rolling installation as claimed in claim 1, wherein the temperature adjusting element is arranged between 1 meter and 25 meters before the cooling device.

7. The casting-rolling installation as claimed in claim 2, wherein the temperature adjusting element is arranged between 0.5 meters and 10 meters, after the last roll stand.

8. The casting-rolling installation as claimed in claim 1, wherein the cooling device comprises one of a laminar, cooling device, turbo-laminar cooling device and a pressure cooling device.

9. A method for treating a workpiece in a casting-rolling installation as claimed in claim 1, wherein the temperature adjusting element comprises a heating device.

10. The method as claimed in claim 9, wherein the temperature adjusting element is arranged after the last roll stand and before the cooling device, and the workpiece is treated using the temperature adjusting element.

11. The method as claimed in claim 9, wherein the temperature adjusting element is arranged after the last roll stand and after the cooling device, and the workpiece is treated using the temperature adjusting element.

12. The method as claimed claim 9, wherein the temperature adjusting element is a heating device, and the workpiece is heated by 10° C. to 150° C., using the heating device.

13. The method as claimed in claim 9, wherein the temperature adjusting element is a heating device, and the workpiece is heated for between 0.1 seconds and 10 seconds, preferably for between 0.1 seconds and 5 seconds, and particularly preferably for between 0.1 seconds and 1 second, using the heating device.
